(19) United States
(12) Patent Application Publication
(10) Pub. No.: US 2013/0219261 A1
(43) Pub. Date: Aug. 22, 2013

(54) APPARATUS, INFORMATION PROCESSING SYSTEM, AND INFORMATION PROCESSING METHOD

(71) Applicants: Xiaofeng HAN, Kanagawa (JP); Yoshihiko Sakawaki, Kanagawa (JP)

(72) Inventors: Xiaofeng HAN, Kanagawa (JP); Yoshihiko Sakawaki, Kanagawa (JP)

(73) Assignee: RICOH COMPANY, LTD., Tokyo (JP)

(21) Appl. No.: 13/766,956

(22) Filed: Feb. 14, 2013

(30) Foreign Application Priority Data
Feb. 17, 2012 (JP) 2012-032624

(51) Int. Cl. G06F 17/22

(52) U.S. Cl. CPC G06F 17/22
USPC 715/234

(57) ABSTRACT

A disclosed apparatus includes a display control unit that causes a screen to be displayed by a display unit indicated by screen information included in a Web page, and a call unit that calls a method corresponding to a character string designated by an argument of a first script included in the Web page, the method being included in a program causing a function to be performed with the apparatus.

### BACKGROUND OF THE INVENTION

1. Field of the Invention

The present invention generally relates to an apparatus, an information processing system, and an information processing method.

2. Description of the Related Art

An example of an image forming apparatus includes browser software for displaying Hyper Text Markup Language (HTML) data acquired via a network or from the inside of an apparatus as an operation screen. There is browser software which enables controlling an apparatus by interpreting a script (hereinafter, “expansion script”) expanded for controlling an apparatus in addition to a display of a screen. An example of the expansion script is a method called “doScan”. The “doScan” is an expansion script indicating an executive command of scanning. According to browser software which can interpret an expansion script, it is possible to provide an expansion script as an Application Program Interface (API) for a browser so that the browser software can be customized (For example, Patent Document 1).

For example, a third-party vendor or the like that develops a new application can cause a Web page to be displayed on browser software using the expansion script. In this case, a service of using a hardware resource of the image forming apparatus can be provided via a Web page.

However, in order to enable using a function of an apparatus such as an image forming apparatus, it is necessary to define an expansion script corresponding to the function, and a process corresponding to the expansion script is installed in browser software. For example, if a fax transmission function is used via a Web page, an expansion request corresponding to the fax transmission function such as “doSendFAX is defined, and the browser software is required to install a process corresponding to “doSendFAX”. The process corresponding to “doSendFAX” is an execution of calling a fax transmission function in, for example, an image forming apparatus.

When the browser software is altered as described above, cumbersome work is required such as uninstallation of browser software installed before the alteration and installation of altered browser software.

Patent Document 1: Japanese Laid-Open Patent Application No. 2006-352845

### SUMMARY OF THE INVENTION

The present invention is provided to solve the above problem. The object of the present invention is to reduce necessity of alteration of a Web browser for enabling the function of an apparatus to be used from a Web page.

One aspect of the embodiments of the present invention may be to provide an apparatus including a display control unit that causes a screen to be displayed by a display unit indicated by screen information included in a Web page, and a call unit that calls a method corresponding to a character string designated by an argument of a first script included in the Web page, the method being included in a program causing a function to be performed with the apparatus.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

### BRIEF DESCRIPTION OF THE DRAWINGS

FIG. 1 illustrates an exemplary structure of an information processing system of an embodiment of the present invention;

FIG. 2 illustrates an exemplary hardware structure of an image forming apparatus of an embodiment of the present invention;

FIG.3 illustrates an exemplary hardware configuration of a program managing apparatus of an embodiment of the present invention;

FIG. 4 illustrates an exemplary hardware configuration of an image forming apparatus and a program managing apparatus of an embodiment of the present invention;

FIG. 5 is a sequence chart for explaining a process performed in an information processing system;

FIG. 6 illustrates a structural example of apparatus information;

FIG. 7 is an example of a screen for scanning to be displayed; and

FIG. 8 is a flow diagram for explaining an effect of doFunction.

### DETAILED DESCRIPTION OF THE PREFERRED EMBODIMENTS

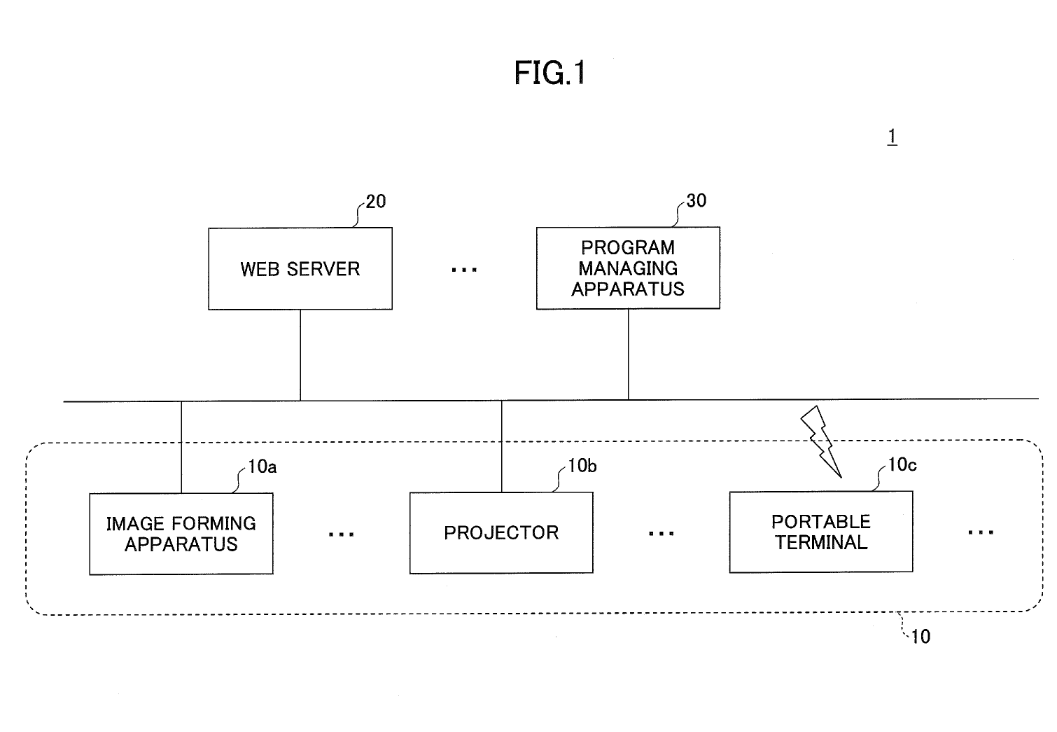

A description is given below, with reference to FIG. 1 through FIG. 8 of embodiments of the present invention. Where the same reference symbols are attached to the same parts, repeated description of the parts is omitted.

Reference symbols typically designate as follows:
1: information processing system;
10: apparatus;
10a: image forming apparatus;
10b: projector;
10c: portable terminal;
11: controller;
12: scanner;
13: printer;
14: modem;
15: operations panel;
16: network interface;
17: SD card slot;
20: Web server;
30: program managing apparatus;
31: program providing unit;
32: apparatus information receiving unit;
33: program memory unit;
34: apparatus information memory unit;
80: SD card;
111: CPU;
112: RAM;
113: ROM;
114: HDD;
115: NVRAM;
121: apparatus browser;
121a: Web page acquiring unit;
121b: drawing unit;
121c: script interpreting unit;
122: apparatus controlling unit;
122a: scan controlling unit;
122b: print controlling unit;
122c: fax controlling unit;
122d: copy controlling unit;
122e: panel controlling unit;
122f: communication controlling unit;
123: downloading unit;
124: apparatus information sending unit;
300: drive device;
301: recording medium;
302: auxiliary memory device;
303: memory device;
304: CPU;
305: interface device; and
B: bus.

Hereinafter, the embodiments are described with reference to the figures. FIG. 1 illustrates an exemplary structure of an information processing system of an embodiment. In the information processing system 1 illustrated in FIG. 1, one or more image forming apparatuses 10a, one or more projectors 10b, one or more portable terminals 10c, or the like are connected to one or more Web servers 20, one or more program managing apparatuses 30, and so on so as to be mutually communicable via a Local Area Network (LAN) or a network (wired or wireless) such as Internet.

The image forming apparatus 10 is a multifunction peripheral which can realize two or more functions among printing, scanning, copying, and sending and receiving faxes in one casing. One function among printing, scanning, copying, and sending and receiving faxes, however, may be employed individually as the image forming apparatus 10a. Within this embodiment, the image forming apparatus 10a includes a Web browser as a program for causing an operations panel (an operations panel 15 to be described later) to display a Web page or do other actions. The function of the Web browser is expanded for the image forming apparatus 10a. Hereinafter, the Web browser, of which function is expanded in conformity with a function peculiar to the apparatus 10, is referred to as an “apparatus browser”.

The projector 10b as a second example of the apparatus 10 is provided to project an image. For example, the projector 10b may include an apparatus browser as a program for causing an operations panel of the projector 10b to execute a display or the like of a Web page.

The portable terminal 10c as the third example of the apparatus 10 is a portable information processing terminal, which can be brought, such as a mobile phone, a smart phone, a tablet terminal, a notebook PC, a Personal Digital Assistant (PDA), or the like. For example, the portable terminal 10c may include an apparatus browser, as a program for causing a Web page to be displayed on a display portion of the portable terminal.

The image forming apparatus 10a, the projector 10b, and the portable terminal 10c are generically referred to as an “apparatus 10”.

One of the function expansions in the apparatus browser is interpretation of a script for controlling the apparatus 10, which is not included in a standard script such as JavaScript (“JavaScript” is a registered trademark). Hereinafter, such a script is referred to as an “expansion script”.

The Web server 20 is a computer for providing a Web page. Within this embodiment, the Web page is data, in which screen information defined based on a predetermined type or a script or the like issued in response to an operation or the like onto a screen displayed based on the screen information such as HyperText Markup Language (HTML) is defined or described. Mutually different Uniform Resource Locators (URL)s are allocated to the Web pages, respectively. When an HTTP request to a certain URL is sent from the apparatus 10, the HTTP request is transferred to the Web server 20 which provides a Web page corresponding to the certain URL.

The program managing apparatus 30 manages a program group, which is installed in the apparatus 10 for causing the apparatus to perform a predetermined function such as a program module or a program component. Specifically, the program managing apparatus 30 stores the program group, and returns a program specified in a download request (an acquisition request) in response to the download request.

Within the embodiment, for convenience, the Web server 20 and the program managing apparatus 30 are separate computers. However, the functions of the Web server 20 and the program managing apparatus 30 can be realized by one computer.

Each of the Web server 20 and the program managing apparatus 30 may be constituted by distributed plural computers.

Further, the Web server 20 or the program managing apparatus 30 may form a part or all of a cloud computing service which provides applications and services to be used by plural users.

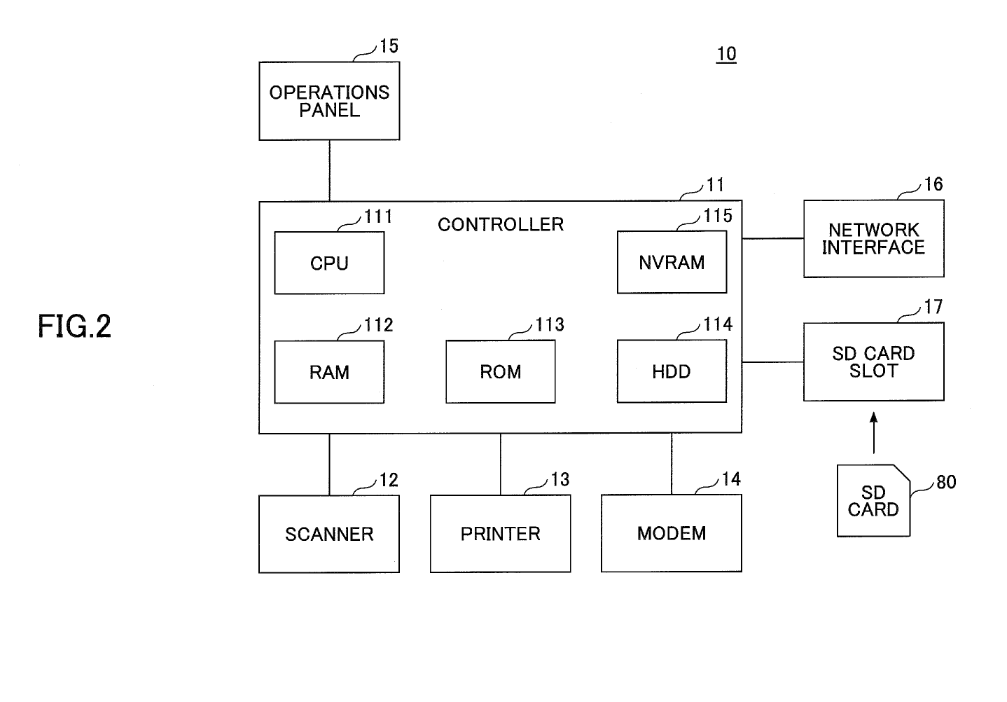

FIG. 2 illustrates an exemplary hardware configuration of the image forming apparatus of the embodiment. Referring to FIG. 2, the image forming apparatus 10a includes hardware such as a controller 11, a scanner 12, a printer 13, a modem 14, an operations panel 15, a network interface 16, an SD card slot 17, or the like.

The controller 11 includes a CPU 111, a RAM 112, a ROM 113, an HDD 114, an NVRAM 115, and so on. Various programs and data used by the programs are stored in the ROM 113. The RAM 112 is used as a memory area for loading the programs, a work area for the loaded programs, or the like. The CPU 111 demonstrates various functions by processing the programs loaded into the RAM 112. The HDD 114 records programs, various data used by the programs, or the like. The NVRAM 115 stores various setup information or the like.

The scanner 12 is hardware (an image reading unit) for reading image data from an original (an original manuscript). The printer 13 is hardware (a printing unit) for printing print data on print paper. The modem 14 is hardware for connecting the image forming apparatus 10 to a telecommunication line (not illustrated) and is used for sending and receiving the image data with fax communications. The operations panel 15 is hardware provided with an input unit for receiving an input from the user by such as a button and a display unit such as a liquid crystal panel. The liquid crystal panel may have a touch panel function. In this case, the liquid crystal panel may have the function of an input unit. The network interface 16 is hardware for connecting the image forming apparatus 10 to a wired or wireless network such as a LAN. The SD card slot 17 is used to read a program recorded in an SD card 80. Said differently, not only the programs stored in the ROM 113 but also the programs stored in the SD card 80 may be loaded into the RAM 112 and executed by the image forming apparatus 10. The SD card 80 may be substituted for by another recording medium such as a CD-ROM or a universal serial bus (USB) memory. The type of a recording medium corresponding to the SD card 80 is not specifically limited, and may be any type of memory. In this case, the SD card slot 17 may be replaced by hardware in conformity with the type of the recording medium.

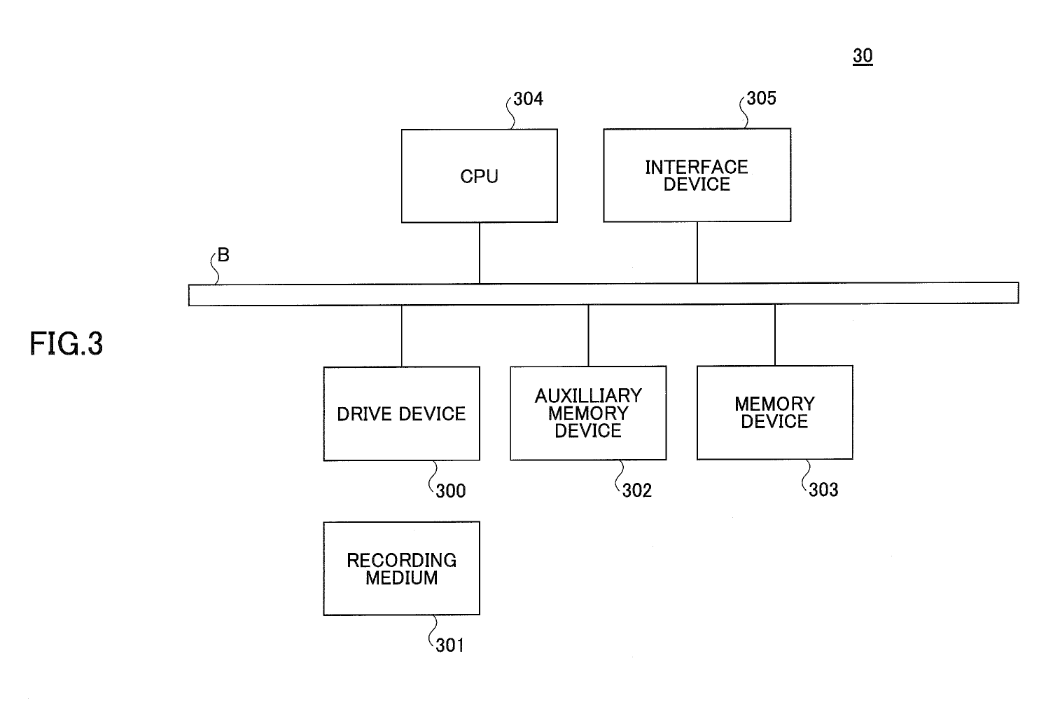

FIG. 3 illustrates an exemplary hardware configuration of the program managing apparatus of the embodiment. The program managing apparatus 30 illustrated in FIG. 3 includes a drive device 300, an auxiliary memory device 302, a memory device 303, a CPU 304 and an interface device 305, or the like, which are mutually connected.

A program implementing processes in the program managing apparatus 30 is supplied by a recording medium 301 such as a CD-ROM. When the recording medium 301 with the program recorded on it is installed in the drive device 300, the program is installed in the auxiliary memory device 302 via the drive device 300 from the recording medium 301. However, the program may not always be installed from the recording medium 301 and may be downloaded from another computer via the network. The auxiliary memory device 302 stores necessary files, data and so on in addition to the installed program.

The memory device 303 reads out the program from the auxiliary memory device 302 when the program is instructed to be invoked and stores the read program in the memory device 303. The CPU 304 performs a function related to the program managing apparatus 30 in conformity with the program stored in the memory device 303. The interface device 305 is used as an interface for connecting to the network.

The Web server 20 includes hardware similar to that in FIG. 3.

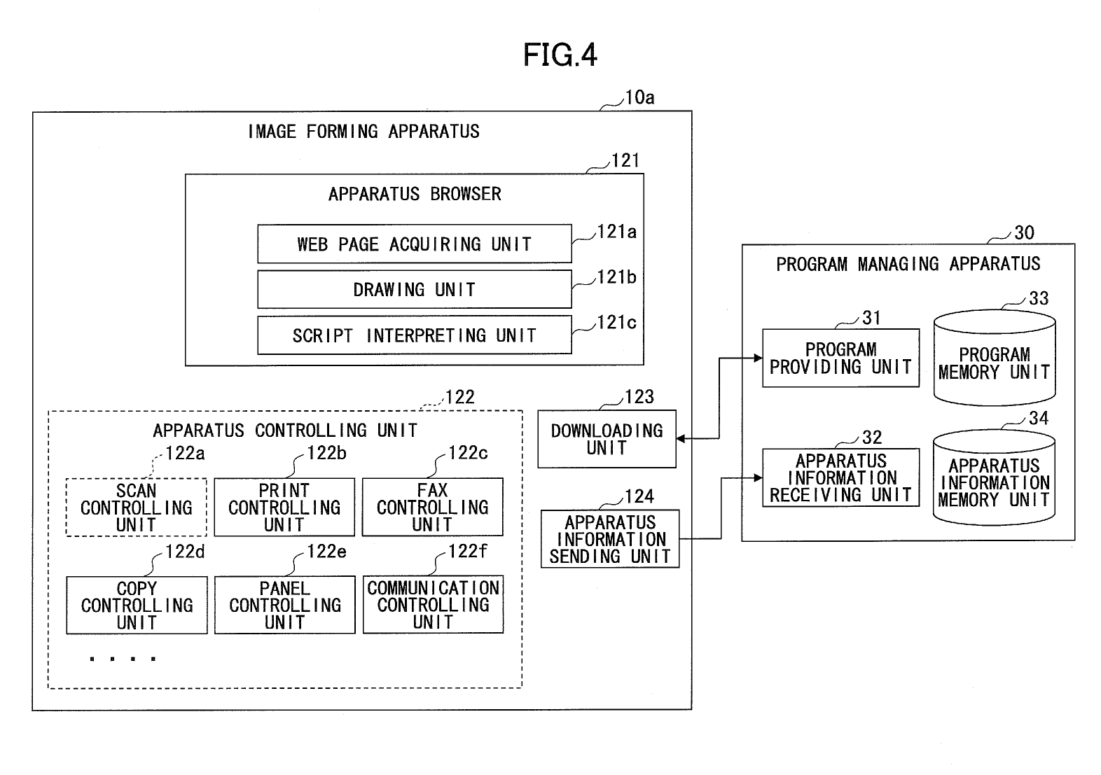

FIG.4 illustrates an exemplary hardware configuration of an image forming apparatus and a program managing apparatus of the embodiment of the present invention.

Referring to FIG. 4, the image forming apparatus 10a includes an apparatus browser 121, an apparatus controlling unit 122, a downloading unit 123, an apparatus information sending unit 124, or the like. These units are realized when the program installed in the image forming apparatus 10a is executed by the CPU 111.

The apparatus browser 121 is as described above. Referring to FIG. 4, the apparatus browser 121 includes a Web page acquiring unit 121a, a drawing unit 121b, and a script interpreting unit 121c. The Web page acquiring unit 121a acquires (downloads) a Web page related to a URL input into the apparatus browser 121 via the network. Within the embodiment, the Web page can be acquired from the Web server 20. The drawing unit 121b interprets screen information contained in the Web page, and draws the screen indicated by the screen information into a video memory of the operation panel 15. The operations panel 15 causes the screen drawn into the video memory to be displayed. Therefore, the drawing unit 121b substantially causes the operations panel 15 to display the screen indicated by the screen information contained in the Web page.

The script interpreting unit 121c interprets the script contained in the Web page acquired by the Web page acquiring unit 121a, and performs a process in compliance with the script. The script interpreting unit 121c causes the apparatus controlling unit 122, the downloading unit 123 or the like to perform the process in compliance with the script.

The apparatus controlling unit 122 is an assembly of program groups to be performed by an image forming apparatus 10a to exercise various functions including functions peculiar to the image forming apparatus 10a in response to a request from a superordinate program. Within the embodiment, the apparatus browser 121 corresponds to the superordinate program for the apparatus controlling unit 122.

Referring to FIG. 4, the apparatus controlling unit 122 includes a scan controlling unit 122a, a print controlling unit 122b, a fax controlling unit 122c, a copy controlling unit 122d, a panel controlling unit 122e, and a communication controlling unit 122f. The apparatus controlling unit 122 is realized by a process in the CPU performed by executing different programs.

The scan controlling unit 122a controls the performance of a scanning function. Referring to FIG. 4, the scan controlling unit 122a is indicated by a broken line. This is because a program causing the image forming apparatus 10a to function as the scan controlling unit 122a is not installed in the image forming apparatus 10a. Said differently, in an initial state of the embodiment, the image forming apparatus 10a does not include the scan controlling unit 122a. The print controlling unit 122b controls the performance of a printing function. The fax controlling unit 122c controls the performance of a FAX sending and receiving function. The copy controlling unit 122d controls the performance of a copying function. The panel controlling unit 122e controls a displaying function or the like of displaying information on the operations panel 15. The communication controlling unit 122f controls a network communicating function.

The apparatus controlling unit 122 (specifically, programs causing the image forming apparatus 10a to function as the apparatus controlling unit 122) has interfaces (API) for receiving requests from superordinate programs, respectively. As an example of the interfaces specifically installed in the apparatus controlling units 122 is a method or a function (hereinafter, collectively referred to as a “method”). For example, the scan controlling unit 122a includes a scan method or the like. The print controlling unit 122b includes print method. The fax controlling unit 122c includes a sendfax method or the like. The copy controlling unit 122d includes a copy method or the like. Each of the panel controlling unit 122e and the communication controlling unit 122f include one or more methods.

The downloading unit 123 acquires or downloads a program causing the image forming apparatus 10a to function as the apparatus controlling unit 122 from a program managing apparatus 30. In the embodiment, for convenience in explanation, the program acquired from the program managing apparatus 30 is provided to cause the image forming apparatus 10a to function as the apparatus controlling unit 122. However, another program to be installed in the image forming apparatus 10a may be downloaded.

The apparatus information sending unit 124 sends a list of identification information of programs installed in the image forming apparatus 10a to the program managing apparatus 30 at a predetermined timing. Within the embodiment, the list is referred to as “apparatus information”. An example of the predetermined timing is a time of starting up the image forming apparatus 10a, a time of changing program configuration in the image forming apparatus 10a, or the like.

The program managing apparatus 30 includes a program providing unit 31, the apparatus information receiving unit 32, or the like. These units are realized when the program installed in the program managing apparatus 30 is executed by the CPU 304. The program managing apparatus 30 uses a program memory unit 33, an apparatus information memory unit 34, and so on. The program memory unit 33, an apparatus information memory unit 34, and so on can be realized by using a memory device or the like connected to the program memory unit 33, an apparatus information memory unit 34, and so on via a network.

The program providing unit 31 acquires the program designated by the acquisition request in response to the acquisition request for the program sent from the downloading unit 123 of the image forming apparatus 10a, and sends the acquired program to the downloading unit 123. The program memory unit 33 stores a program group causing the apparatus 10 to function.

The apparatus information receiving unit 32 receives the apparatus information sent from the apparatus information sending unit 124 of the image forming apparatus 10a. The apparatus information receiving unit 32 stores the received apparatus information in the apparatus information memory unit 34.

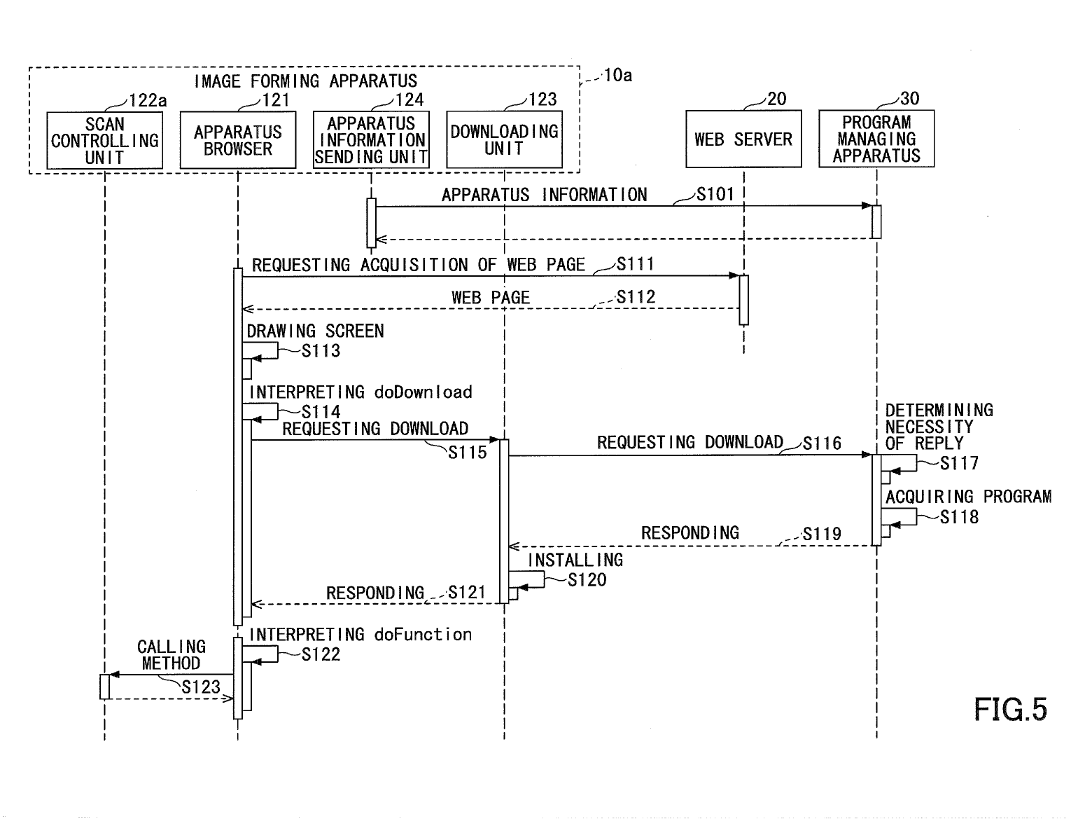

Hereinafter, the procedure followed by the information processing system 1 is described. FIG. 5 is a sequence chart for explaining a process performed in the information processing system.

For example, in response to a start-up of the image forming apparatus 10a, a change in a program structure, or the like, the apparatus information sending unit 124 sends apparatus information including a list of the programs installed in the image forming apparatus 10a to the program managing apparatus 30 in step S101. The list of the identification information is acquired by, for example, the NVRAM 115 or the HDD 114.

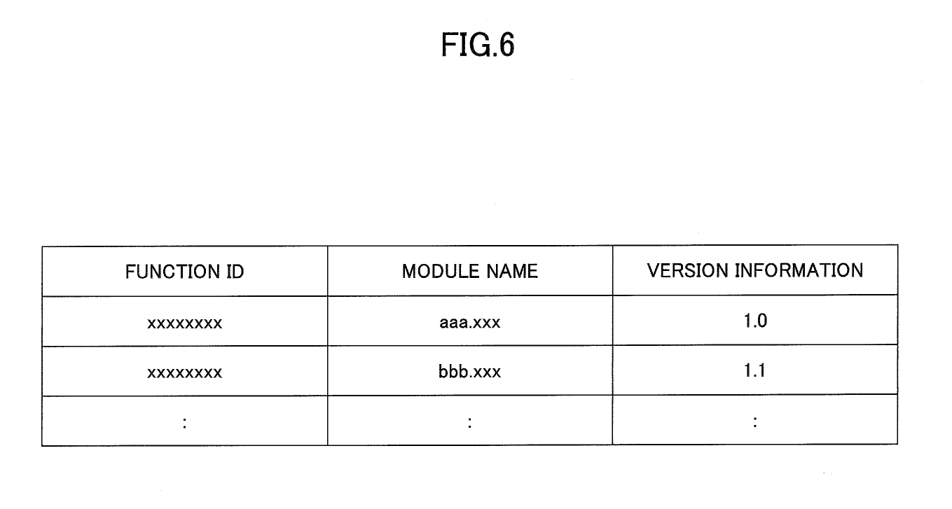

FIG. 6 illustrates a structural example of apparatus information. Referring to FIG. 6, the apparatus information includes a function ID, a module name, version information, or the like of each program in the image forming apparatus 10a.

The function ID is identification information indicative of a program function. For example, the function ID has a value indicative of a program function ID and a scanning function, which cause the image forming apparatus 10a to function as the scan controlling unit 122a. For example, the module name is identification information of an entity of a program. An example of the module name is a file name of a file into which a program is stored. Within the embodiment, the function ID corresponds to the module name in a one-to-one relationship. The version information is so-called version information provided when the version of a program is managed.

The apparatus information may be constituted by a list of the other identification information. If the program can be identified only by the module name and the version information, the function ID may not be included in the apparatus information. If the version is not managed, the version information may not be included in the function ID.

The apparatus information includes identification information of the body of the image forming apparatus 10a. The identification information is used for identifying the image forming apparatuses 10a. For example, the identification information is manufacturer's serial numbers 10a of the image forming apparatuses 10a. Hereinafter, the identification information of the bodies is referred to as a “body number”. For example, the body number is stored in a ROM 113.

When the apparatus information receiving unit 32 of the program managing apparatus 30 receives apparatus information, a list of the function ID, the module name, and the version information, which are included in the apparatus information, are associated with the body number included in the apparatus information and stored in the apparatus information memory unit 34.

Subsequently, a user of the image forming apparatus 10a inputs the URL for a certain Web page. The Web page acquiring unit 121a of the apparatus browser 121 sends a HTTP request indicative of an acquisition request for the Web page to the URL in step S111. Input of the URL may be designated by other than the input of a character string forming the URL. For example, the URL may be input by selecting links on a screen displayed on the operations panel 15. Step S111 may be performed asynchronously with step S101.

The Web server 20 returns the Web page corresponding to the URL designated by the HTTP request when the HTTP request is received in step S112. The returned Web page is received by the Web page acquiring unit 121a of the apparatus browser 121.

Subsequently, the drawing unit 121b of the apparatus browser 121 draws a screen in a video memory of the operations panel 15 based on the screen information included in the Web page acquired by the Web page acquiring unit 121a in step S113. Consequently, the screen is displayed on the operations panel 15. For example, the screen for receiving an execution command of scanning (hereinafter, referred to as a “screen for scanning”) may be displayed.

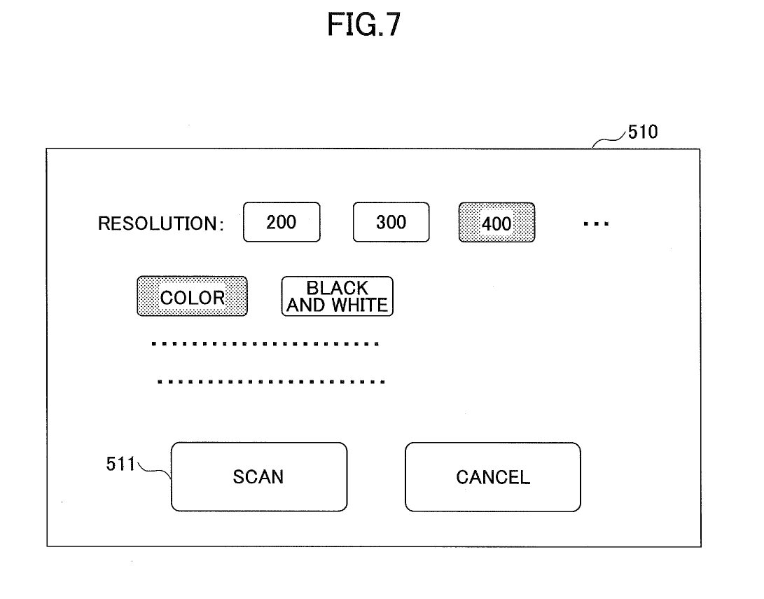

FIG. 7 is an exemplary display of the screen for scanning. Referring to FIG. 7, a screen for scanning 510 includes resolution, a selection between “color” or “black and white”, an input region of setup information for scanning, a scan start button 511, and the like.

Subsequently, the script interpreting unit 121c of the apparatus browser 121 performs an interpretation of “doDownload”, which is one of the expansion scripts included in the Web page in step S114. The Web page is defined so that “doDownload” can be called when the screen is displayed.

The “doDownload” is a method of the expansion script indicative of a download command of downloading a program. For example, the interface specification of “doDownload” is as follows.

doDownload (<function ID>, <version information>)

Said differently, in the argument of “doDownload”, the function ID and the version information are designated as an example of the identification information of the program. If the destination of the request for the download (the program managing apparatus of the embodiment) is not fixed, the identification information of the destination of the request for the download (for example, the IP address and the port number or the URL) may be designated as the argument of “doDownload”. Instead of the function ID, the module name may be designated.

The script interpreting unit 121c designates the function ID designated in the argument and the version information and requests the downloading unit 123 to start downloading in step S115. The downloading unit 123 sends a download request in which the function ID, the version information, and the body number of the image forming apparatus 10a are designated to the program providing unit 31 of the program managing apparatus 30 in step S116. Along with the download request, the apparatus information may be sent. Said differently, the downloading unit 123 may have the function of the apparatus information sending unit 124. In this case, step S101 may not be performed.

When the destination of the request for the download is fixed, the IP address and the port number for the program providing unit 31 may be stored in, for example, the HDD 114. The downloading unit 123 specifies the destination of the request for the download based on the IP address, the port number, the URL or the like. Meanwhile, when the argument of “doDownload” has the identification information, the downloading unit 123 specifies the destination of the request for the download based on the identification information.

When the program providing unit 31 receives the request for the download, it is determined whether a reply is necessary for the program corresponding to the function ID and the version information, which are designated by the request for the download, in step S117. Specifically, the program providing unit 31 acquires a list of the function ID, the module name, and the version information, which are stored in association with the body number designated by the request for the download in the apparatus information memory unit 34, from the apparatus information memory unit 34. The program providing unit 31 determines whether a combination of the function ID and the version information, which are designated in the request for the download, is included in the list. When the combination is included in the list, the program related to the request for the download is already installed in the image forming apparatus 10a that is the destination of the request for the download. Therefore, in this case, the program providing unit 31 determines that the reply is unnecessary. Meanwhile, when the combination is not included in the list, the program related to the request for the download is not installed in the image forming apparatus 10a that is the destination of the request for the download. Therefore, in this case, the program providing unit 31 determines that the reply is necessary.

In a case where it is determined that the reply is necessary, the program providing unit 31 acquires a program having a module name (a file name) related to the combination of the function ID and the version information designated by the request for the download out of the list of the module names and the version information, which is stored in the apparatus information memory unit 34 in association with the body number designated in the request for the download.

Subsequently, the program providing unit 31 returns a response to the request for the download in step S119. In a case where it is determined that the reply is unnecessary in step S117, the response does not include the program related to the request for the download. Meanwhile, if it is determined that the reply is necessary in step S117, the response includes the program acquired in step S118.

When the request for the download includes the program, the downloading unit 123 performs installation of the program into the image forming apparatus 10a in step S120. As a result, a new apparatus controlling unit 122 is added to the image forming apparatus 10a. The following explanation is given on the premise that the scan controlling unit 122a is added as the new apparatus controlling unit 122. Said differently, the downloaded program is a program causing the image forming apparatus 10a to function as the scan controlling unit 122a.

Subsequently, the downloading unit 123 returns a response to the request for the download in step S115 to the script interpreting unit 121c in step S121.

Thereafter, the screen for scanning 510 of the apparatus browser 121 is in an input wait state waiting for an input from a user.

When the setup information is set in the screen for scanning and the scan start button 511 is pushed, the script interpreting unit 121c performs the interpretation of “doFunction”, which is one of the expansion scripts included in the Web page in which the screen for scanning 510 is displayed in step S122. Said differently, the Web page is defined so as to call “doFunction” in response to a press-down of the scan start button 511.

The “doFunction” is a method of the expansion script indicating a call command of a method of the apparatus controlling unit 122. For example, the “doFunction” has the following interface specification.

doFunction (<method name>, argument 1, argument 2, . . . , argument N)

In the method name being the first argument, the method name of the apparatus controlling unit 122 to be called is designated. As for the second and subsequent arguments, the argument of the method related to the method name is designated. Therefore, the numbers of the arguments of the second and subsequent arguments differ in response to the method name designated by the first argument.

As described, “doFunction” is the expansion script enabling to call plural methods of the apparatus controlling unit 122 from the Web page. Within the embodiment, the following description is given on the premise that the following values are designated in the arguments.

doFunction (scan, <resolution>, <color or black and white>, . . . )

The “scan” in the first argument is a method name of a method provided for the scan controlling unit to receive the scan execution request. It is defined in the second and subsequent arguments such that the setup value in the screen for scanning 510 is set.

Based on the definition of “doFunction”, the script interpreting unit 121c calls the scan method of the scan controlling unit 122a in, for example, the following form in step S123.

scan (<resolution>, <color or black and white>, . . . )

Said differently, the script interpreting unit 121c interprets a character string designated as the first argument of doFunction as a method to be called, and interprets the second and subsequent arguments for the method as related to the method name. Therefore, the argument of the scan method is designated as the values of the second and subsequent arguments of “doFunction”.

Here, the program related to the scan controlling unit 122a having the scan method is downloaded by doDownload, and installed in the image forming apparatus 10a. Therefore, the scan method is normally called with a high probability. Said differently, “doDownload” is defined inside the Web page in order to assure the existence of the program having the method called by “doFunction”. However, if it is unnecessary to assure the existence of the program having the method called by “doFunction”, “soDownload” may not be defined inside the Web page.

The scan controlling unit 122a causes the image forming apparatus 10a to scan by controlling the scanner 12 or the like in response to the call by the scan controlling unit 122a.

As described, the apparatus browser 121 can interpret “doFunction” as an expansion script, which can be used in common with plural methods in the apparatus controlling unit 122. Said differently, “doFunction” is not only used for the scan method but also for other plural methods (a print method, a send fax method, a copy method, or the like) held by the apparatus controlling unit 122 in the embodiment. Therefore, for each method disclosed by the apparatus controlling unit 122, necessity of defining the expansion script can be reduced. As a result, the necessity of alteration of the apparatus browser for enabling it to use the function of the image forming apparatus 10a from the Web page can be reduced.

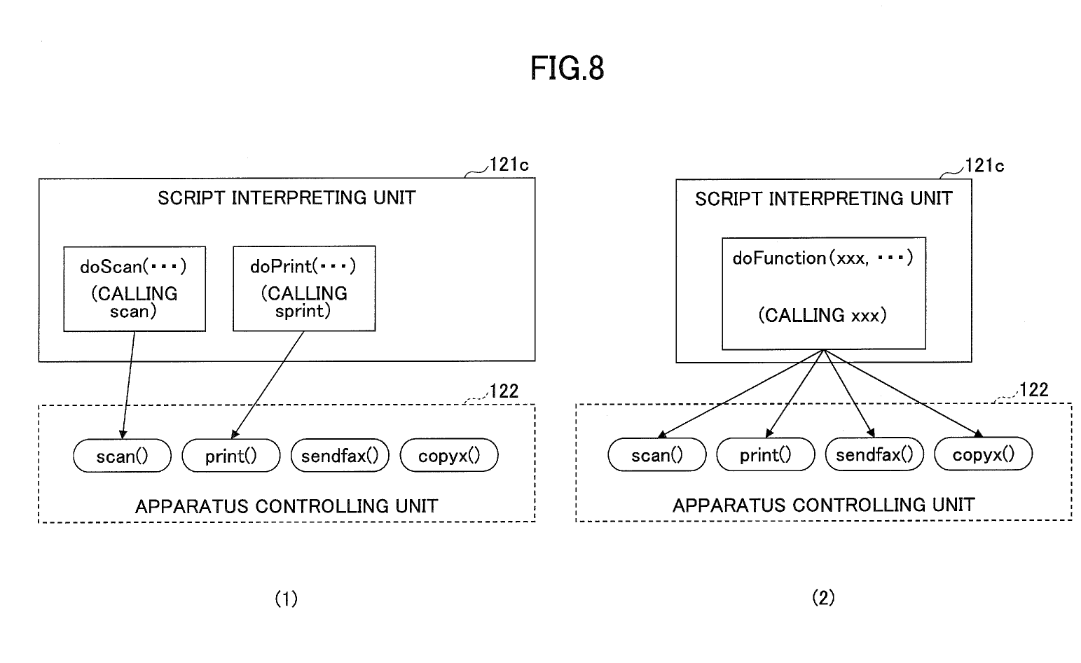

This is further explained in reference to figures. FIG. 8 is a flow diagram for explaining the effect of doFunction.

Referring to FIG. 8, in a part of (1), an example where the expansion script is defined for each function of the image forming apparatus 10a (for each method of the apparatus controlling unit 122) is indicated. The “doScan” is an example of the expansion script indicative of a scan execution command. The “doPrint” is an example of the expansion script indicative of a print execution command.

In this case, in the definition of processing in response to “doScan” of the script interpreting unit 121c, a call command of the scan method is included. Similarly, in the definition of processing in response to “doPrint” of the script interpreting unit 121c, a call command of the print method is included. Thus, the character strings indicative of the method names in the apparatus controlling unit 122 such as “scan” or “print” are included in the definition of processing of the script interpreting unit 121c. Therefore, for example, if the sendfax method or the copy method in the apparatus controlling unit 122 is used from the Web page, definitions of processing similar to “doScan” or “doPrint” are required to be added to the script interpreting unit 121c.

Meanwhile, in the part (2), an example is indicated where the script interpreting unit 121c can interpret “doFunction”. In this case, the script interpreting unit 121c merely call the method related to the method name matching the character string designated by the first argument of “doFunction”. Said differently, the method name of the apparatus controlling unit 122 is not statically included in the definition of processing of the script interpreting unit 121c. Therefore, without adding the definition of processing of the new expansion script to the script interpreting unit 121c, the methods in the apparatus controlling unit 122 can be used from the Web page.

Here, the method name of “doFunction” can be appropriately changed.

Further, the script interpreting unit 121c of the embodiment can interpret “doDownload”. Therefore, it is possible to make a Web page by which the program having the method called by “doFunction” is previously downloaded before the execution of “doFunction” and the downloaded program is automatically installed in the image forming apparatus 10a. As a result, for example, in a case where the method name for the program, which is not installed in the image forming apparatus 10a, is designated by the first argument of “doFunction”, it is possible to enhance the probability of normally executing “doFunction”.

The request for the download for the downloading unit 123 can be defined by “doFunction”. In this case, a dynamic call of a method such as download ( ), included in the downloading unit 123, is enabled. The “download” may be designated in the first argument of “doFunction”. The function ID and the version information may be designated in the second argument and the third argument, respectively.

Further, the program managing apparatus 30 determines the necessity of the reply for the program related to the request for the download based on the list of the programs, which is installed in the image forming apparatus 10a. Therefore, an unnecessary increment of network load or the like caused by a reply for the program already installed in the image forming apparatus 10a can be prevented.

The Web page may not be always acquired from the Web server 20 via the network. For example, the Web page may be stored in the HDD 14 of the image forming apparatus 10a. In this case, the Web page acquiring unit 121a may acquire the Web page from the HDD 114.

Further, the embodiment is applicable to the projector 10b, the portable terminal 10c, or the like. Further, the embodiment may be applicable to an apparatus (not illustrated) with an operations panel into which the Web browser can be mounted. Such an apparatus is a digital camera or the like.

The drawing unit 121b is an example of the display control unit in the embodiment. The script interpreting unit 121c is an example of a call unit. The apparatus information sending unit 124 is an example of a sending unit. The operations panel 15 is an example of a display unit. The apparatus information receiving unit 32 is an example of a receiving unit. The program providing unit 31 is an example of a reply unit.

Thus, within the embodiment, it is possible to reduce the necessity of the alteration of a Web browser in enabling functions of an apparatus being used from the Web page.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the apparatus has been described in detail, it should be understood that various changes, substitutions, and alterations could be made thereto without departing from the spirit and scope of the invention.

This patent application is based on Japanese Priority Patent Application No. 2012-032624 filed on Feb. 17, 2012, the entire contents of which are hereby incorporated herein by reference.

What is claimed is:

1. An apparatus comprising:
a display control unit that causes a screen to be displayed by a display unit indicated by screen information included in a Web page; and
a call unit that calls a method corresponding to a character string designated by an argument of a first script included in the Web page, the method being included in a program causing a function to be performed with the apparatus.

2. The apparatus according to claim 1, further comprising:
an acquisition unit that acquires via a network a program related to identification information designated in an argument of a second script included in the Web page via a network,
wherein the call unit calls a method included in the program acquired by the acquisition unit, the method corresponding to the character string designated by the argument of the first script.

3. The apparatus according to claim 2, further comprising:
a send unit that sends a list of identification information of programs installed in the apparatus to a program managing apparatus connected via the network,
wherein the acquisition unit receives the program related to the identification information in a case where it is determined that the identification information is not included in the list as a result of sending an acquisition request designated by the argument of the second script.

4. The apparatus according to claim 1,
wherein when a URL for the Web page is sent to an outside, the Web page corresponding to the URL is returned from the outside to the apparatus.

5. An information processing system comprising:
an apparatus; and
a program managing apparatus connected to the apparatus via a network,
wherein the apparatus includes
a send unit that sends a list of identification information of programs installed in the apparatus to the program managing apparatus, and
a display control unit that causes a display unit to display a screen indicated by screen information included in a Web page;
an acquisition unit that receives a program related to the identification information after sending an acquisition request designated by an argument of a second request; and
a call unit that calls a method included in the program, the method corresponding to a character string designated by an argument of a first script included in the Web page, and
wherein the program managing apparatus includes
a receive unit that receives the list; and
a reply unit that returns the program related to the identification information in a case where it is determined that the identification information designated by the acquisition request of the program is not included in the list as a result of the determination whether the identification information designated by the acquisition request of the program is included in the list.

6. The information processing system according to claim 5,
wherein the identification information includes at least one of identification information of a function and version information.

7. The apparatus according to claim 5,
wherein when a URL for the Web page is sent to an outside, the Web page corresponding to the URL is returned from the outside to the apparatus.

8. An information processing method comprising:
sending, with a sending unit, a list of identification information of programs, and
causing, with a display control unit, a screen to display a screen indicated by screen information included in a Web page;
receiving, with an acquisition unit, the program related to the identification information after sending an acquisition request designated by the argument of the second request;
calling, with a call unit, a method included in the program, the method corresponding to a character string designated by an argument of a first script included in the Web page;
receiving, with a receive unit, the list; and
returning, with a reply unit, the program related to the identification information in a case where it is determined that the identification information designated by the acquisition request of the program is not included in the list as a result of the determination whether the identification information designated by the acquisition request of the program is included in the list.

9. The information processing method according to claim 8,
wherein the identification information includes at least one of identification information of a function and version information.

10. The information processing method according to claim 8, further comprising:
sending a URL for the Web page to a Web server; and
receiving the Web page corresponding to the URL from the Web server.
